(19) United States
(12) Patent Application Publication
(10) Pub. No.: US 2026/0317664 A1
(43) Pub. Date: Oct. 15, 2026

(54) CLEANING SHEETS OR ROLLS FOR IMAGE RECORDING DEVICES

(71) Applicant: Polaroid IP B.V., Enschede (NL)

(72) Inventors: Wei YOU, Taichung City (TW); Yi-Hsiu WU, Taipei City (TW); Rong-Chang LIANG, Cupertino, CA (US)

(21) Appl. No.: 19/177,205

(22) Filed: Apr. 11, 2025

(51) Int. Cl. C11D 17/04; B08B 1/14; B08B 1/30; B08B 1/40; B41J 3/44; B41J 3/46; B41J 29/17; C11D 7/50; C11D 17/00

(52) U.S. Cl. CPC C11D 17/049; B08B 1/143; B08B 1/30; B08B 1/40; B41J 3/445; B41J 3/46; B41J 29/17; C11D 7/5027; C11D 17/0039

(57) ABSTRACT

Devices, microcapsules and methods are provided, for cleaning and calibrating imaging apparatuses, including a deformable polymeric layer including one or more pressure-releasable microcapsules including a functional additive, and optionally a calibration code printed on at least one side of the device. The resulting cleaning and calibration devices achieve improved cleaning efficiency as well as improvement in calibration, static charge, friction, and/or corrosion controls to improve imaging and printing performance and quality.

### FIELD

The present technology generally relates to cleaning and calibration devices and methods for an imaging apparatus. In particular, the present technology relates to various compositions and devices for cleaning and calibrating imaging apparatuses, which include a deformable polymeric layer including one or more pressure-releasable microcapsules including a functional additive, and optionally a calibration code on at least one side of the device.

### BACKGROUND

The following discussion is provided to aid the reader in understanding the disclosure and is not admitted to describe or include prior art thereto.

Dust, dirt, debris or other contaminants accumulated inside a printer can cause printing defects and undesirable scratches on its components, which may also result in deterioration of printer registration and alignment. Periodic cleaning of the printer is thus crucial to maintain print quality and extend the printer lifetime. Various cleaning mechanisms, using low surface tension cleaning fluids or movable cleaning structures, have been studied. However, the printers needed to implement these methods are often quite noisy and bulky since they require a collection and disposal mechanism for the excessive cleaning fluid and debris, and/or additional space to accommodate the moving parts. The printer may be dissembled and cleaned from time to time and a lubricant may be carefully applied along the moving path to ensure smooth medium transportation. However, this type of printer maintenance is time consuming and difficult, if not impractical, to implement for systems such as portable devices, particularly for low-cost consumer applications.

To ensure consistent printing, a calibration mechanism is often provided to allow compensation for the batch-to-batch variations of the media and devices. Thermal printers with color calibration based on test image data stored in memory and various coding and decoding calibration technologies are being developed. However, typical cleaning devices are incapable of providing additional useful features including calibration, static charge, friction, and/or corrosion controls to improve printing quality and printer longevity. Thus, there exists a need for a new, simple, yet effective, low-cost, user, and environmentally-friendly solution to keep the printer clean, to improve calibration procedures and to improve the static charge, friction, and/or corrosion controls. The devices and methods of the present technology meet these needs while addressing the issues related to conventional techniques.

### SUMMARY

In one aspect, which may be combined with any other aspect or embodiment, the present disclosure relates to a cleaning device for an imaging apparatus, the cleaning device comprising (i) a substrate having a first surface and a second surface, (ii) a deformable polymeric layer at least partially covering the first surface of the substrate, the deformable polymeric layer optionally having a textured pattern, and (iii) a plurality of pressure-releasable microcapsules disposed on or embedded in the deformable polymeric layer, one or more of the pressure-releasable microcapsules comprising an outer shell which encapsulates at least one functional additive.

In some embodiments, the cleaning device is a cleaning sheet or a cleaning roll. In some embodiments, the plurality of pressure-releasable microcapsules are embedded or partially embedded in the deformable polymeric layer. In some embodiments, the plurality of pressure-releasable microcapsules are coated on at least one surface of the deformable polymeric layer. In some embodiments, the outer shell of the pressure-releasable microcapsules comprises a crosslinked polymeric layer. In some embodiments, the plurality of pressure-releasable microcapsules have an average microcapsule diameter of from about 1 micrometer to about 15 micrometers.

In some embodiments, the at least one functional additive included in the pressure-releasable microcapsules comprises a lubricant, a slipping agent, a wax, an antistatic agent, a corrosion inhibitor, a diluent, a solvent, a stabilizing agent, a surfactant, a film forming material, an antimicrobial, a perfume material, or flavor material. In some embodiments, the lubricant includes at least one of an olefin copolymer (OCP) or oligomer, a polyalphaolefin (PAO), or a vegetable oil. In some embodiments, the vegetable oil is canola oil.

In some embodiments, the substrate comprises a polymer film, foam, woven or non-woven fabrics, paper, cardboard stock, synthetic paper, and their blends, laminates, or composites. In some embodiments, the polymer film comprises biaxially oriented polypropylene (BOPP), polyethylene terephthalate (PET), polyethylene naphthalate (PEN), polybutylene terephthalate (PBT), liquid crystalline polymers (LCP), polyvinylchloride (PVC), polystyrene, polyacrylate, polymethacrylate, polycarbonate, polyurethane (PU), polylactic acid (PLA), high density polyethylene (HDPE), low density polyethylene (LDPE), linear low density polyethylene (LLDPE), metallocene polyethylene (mPE), biaxially oriented nylon (BON), polyethylene acrylic acid (EAA), polyethylene vinyl acetate (EVA), polyethylene maleate (EMA), and their copolymers, blends, or composites of a combination of any two or more thereof. In some embodiments, the polymer film comprises biaxially oriented polypropylene and polyethylene terephthalate.

In some embodiments, the deformable polymeric layer comprises a rubber (i.e. rubbery) or elastomeric polymer. In some embodiments, the rubber polymer is selected from the group consisting of silicone rubber, acrylic rubber, natural rubber, acrylonitrile-butadiene rubber, styrene butadiene rubber, alpha-methylstyrene butadiene rubber, neoprene rubber, ethylene propylene diene monomer (EPDM), rubber, ethylene propylene (EPM) rubber, polyurethane rubber (PUR), polybutadiene-polyurethane, silicone-modified polyurethane, and derivatives thereof; vulcanized or non-vulcanized copolymers; block copolymers; graft copolymers; interpenetration networks thereof; blends; composites; or a combination of any two or more thereof. In some embodiments, the rubber polymer is a silicone rubber. In some embodiments, the deformable polymeric layer has thickness of from about 3 μm to about 30 μm.

In some embodiments, at least a portion of the deformable polymeric layer has a textured pattern. In some embodiments, the textured pattern comprises one or more of a trench, a strip, an indentation, a groove, or a bump. In some embodiments, the textured pattern is generated by one or more of embossing, engraving, sand blasting, stripe coating, printing, lithography, and laser ablation. In some embodiments, the deformable polymeric layer comprises a foam or sponge. In some embodiments, the cleaning device further includes a calibration code present on at least one side of the cleaning device. In some embodiments, the cleaning device further includes a calibration code affixed or printed on at least one side of the cleaning device.

In another aspect, which may be combined with any other aspect or embodiment, the present disclosure relates to a calibration device for an imaging apparatus, the calibration device comprising (i) a substrate having a first surface and a second surface, (ii) a deformable polymeric layer at least partially covering the first surface of the substrate, and (iii) a calibration code printed on the first or the second surface of the substrate, or on the deformable polymeric layer, or both, wherein the calibration code provides characteristic information of the imaging apparatus, characteristic information of a medium used in the imaging apparatus, or characteristic information for both of the imaging apparatus or medium used therein.

In some embodiments, the calibration device is a calibration sheet or roll. In some embodiments, the characteristic information of the imaging apparatus comprises manufacturing batch number, manufacturing information, specifications of key parts, or a combination thereof. In some embodiments, the characteristic information of the medium comprises manufacturing batch number, manufacturing information, coefficient of friction, surface roughness, thickness, reflectivity, and media response curves, or any combination thereof. In some embodiments, the calibration device further includes a plurality of pressure-releasable microcapsules disposed on or embedded in the deformable polymeric layer, wherein the pressure-releasable microcapsule comprises an outer shell which encapsulates at least one functional additive.

In some embodiments, the imaging apparatus is selected from the group consisting of a photoprinter, a copier, a thermal printer, a photothermal printer, an inkjet printer, an electrophotographic printer, a portable printer, a pocket printer, a multifunction printer, an instant camera, and any combination thereof. In some embodiments, the photoprinter is equipped with a LCD, LED, VED or OLED.

In one aspect, which may be combined with any other aspect or embodiment, the present disclosure relates to a method for cleaning an imaging apparatus having a first feed roller in contact with a printhead configured to print on a print media, and a second feed roller along a print media path, wherein the method includes supplying a cleaning device to the imaging apparatus, moving the cleaning device along the print media path in contact the first feed roller and the second feed roller, while simultaneously releasing the at least one functional additive onto the printhead and/or other parts of the imaging apparatus along the print media path, and removing dust and contaminants adhered to the printhead and/or other parts of the imaging apparatus with the cleaning device.

In another aspect, which may be combined with any other aspect or embodiment, the present disclosure relates to a method for calibrating an imaging apparatus having a first feed roller in contact with a printhead configured to print on a print media, a second feed roller along a print media path, wherein the method includes supplying a calibration device to the imaging apparatus, moving the calibration device along the print media path in contact the first feed roller and the second feed roller, while simultaneously reading the calibration code and cleaning the device, and providing characteristic information from the calibration code to a controller for automatically adjusting at least one calibration setting based on the characteristic information received from the calibration code.

In another aspect, which may be combined with any other aspect or embodiment, the present disclosure relates to a method for calibrating an imaging apparatus having a first feed roller in contact with a printhead configured to print on a print media, a second feed roller along a print media path, wherein the method includes supplying a calibration device to the imaging apparatus, moving the calibration device along the print media path in contact the first feed roller and the second feed roller, while simultaneously reading the calibration code and releasing the at least one functional additive onto the printhead and/or other parts of the imaging apparatus along the print media path, and providing characteristic information from the calibration code to a controller for automatically adjusting at least one calibration setting based on the characteristic information received from the calibration code.

These and other features, together with the organization and manner of operation thereof, will become apparent from the following detailed description when taken in conjunction with the accompanying drawings.

### BRIEF DESCRIPTION OF THE DRAWINGS

The details of one or more embodiments are set forth in the accompanying drawings and the description below. Other features, aspects, and advantages of the disclosure will become apparent from the description, the drawings, and the claims. In the drawings, like reference numerals are used throughout the various views to designate like components.

FIG. 1A shows a cleaning sheet comprising a deformable polymeric coating comprising additive microcapsules embedded therein, according to an example embodiment.

FIG. 1B shows a patterned deformable polymeric coating comprising additive microcapsule coating, according to an example embodiment.

FIG. 2 shows a perspective view of a portable optical printer, according to an example embodiment.

FIG. 3 shows an example of a color calibration sheet for portable printers.

FIG. 4 is a Table showing optical microscopy (OM) micrographs of the rust spots and 20° gloss of the copper plate samples for the cleaning sheets of Example 5.

It will be recognized that some or all of the figures are schematic representations for purposes of illustration. The figures are provided for the purpose of illustrating one or more embodiments with the explicit understanding that they will not be used to limit the scope or the meaning of the claims. The depiction of a particular height, length, width, relative sizing, quantity, and the like, are intended to serve as examples only, and are not intended to limit the scope of the present technology.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

Features may be described herein as part of the same or separate aspects or embodiments of the present technology for the purpose of clarity and a concise description. It will be appreciated by the skilled person that the scope of the present technology may include embodiments having combinations of all or some of the features described herein as part of the same or separate embodiments.

Various techniques and mechanisms of the present technology will sometimes be described in singular form for clarity. However, it should be noted that some embodiments include multiple iterations of a technique or multiple instantiations of a mechanism unless noted otherwise. In the following description, numerous specific details are set forth in order to provide a thorough understanding of the present technology. Particular example embodiments of the present technology may be implemented without some or all of these specific details. In other instances, well known process operations have not been described in detail.

The following terms are used throughout and are as defined below.

As used herein and in the appended claims, singular articles such as “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified. The expression “comprising” means “including, but not limited to.” Thus, other non-mentioned substances, additives, carriers, or steps may be present. Unless otherwise specified, “a” or “an” means one or more.

Unless otherwise indicated, all numbers expressing quantities of properties, parameters, conditions, and so forth, used in the specification and claims are to be understood as being modified in all instances by the term “about.” Accordingly, unless indicated to the contrary, the numerical parameters set forth in the following specification and attached claims are approximations. Any numerical parameter should at least be construed in light of the number reported significant digits and by applying ordinary rounding techniques. The term “about” when used before a numerical designation, e.g., temperature, time, amount, and concentration including range, indicates approximations which may vary by (+) or (−) 10%, 5% or 1%.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

As used herein, the term “deformable polymeric layer” refers to a layer, which may recover to its initial state by substantially 100% (for example, about 99% or more, about 99.9% or more, about 99.5% or more, about 95% or more, or about 90% or more) after the pressure applied on it is released. Such a layer can be, e.g., elastomeric.

Further, certain terms are used throughout the description and following claims to refer to particular components. As one skilled in the art will appreciate, hardware manufacturers may refer to a component by different names.

Certain aspects of the imaging systems of the present technology, for example, the primers, microcapsules, and microcapsule imaging sheets, are generally described in U.S. Pub. 2023/0393459, U.S. Pat. Nos. 12,210,282, 12,214,603, and U.S. Pub. 2024/0184198. The entire contents of these applications and patents are incorporated herein by reference in their entireties.

Typical systems and methods for cleaning and calibrating imaging devices suffer from several drawbacks. For example, cleaning solutions contain hazardous volatile organic compounds (VOCs), a solvent sinks and wash ink trays require downstream solvent removal and recycling, roller wash-up blades and ink blades require proper alignment and controlled speed. Other known methods involve the use of cleaning tools comprising liquid cleaners, fibers, brushes, or tacky materials to clean the printer. However, in addition to foreign particles, dust, debris, etc., the inventors of the present application note that static charge may be accumulated in the printer, particularly along the medium moving path, and the friction between parts may increase after prolonged printing. The static charge may cause further accumulation of foreign particles, dust, debris, etc., particularly in outdoor applications, which may be reduced or discharged by applying a conductive coating on the moving parts or using conductive or metallic parts, which are often quite costly. Moreover, the gradual increase in friction may cause deterioration of printer registration and alignment, and results in undesirable striation and banding on the printed images. The present inventors have discovered devices and methods which address these issues, and which meet the needs for high-quality, reproducible cleaning and calibrations solutions for imaging devices, e.g., portable printing or imaging applications, which also offer a printing path of low static charge and consistent friction.

Various embodiments of the present technology described herein relate to systems, apparatus, devices, microcapsules, sheets, rolls and methods for use in printing and media applications, particularly for cleaning and calibration purposes. The present disclosure provides devices and methods for cleaning and/or calibrating imaging apparatus. In general, effective cleaning and calibration of imaging apparatus has a variety of benefits, for example, removing dust and contaminants from paper feed rollers, removing ink residues, lowering the static charge, reducing friction and corrosion controls, smoothing irregular surfaces, and dislodging paper debris, providing consistent printing quality, and compensating for the batch-to-batch variations of the media and devices.

An aspect of the present disclosure is directed to cleaning devices for an imaging apparatus, which includes a substrate, a deformable polymeric layer, and a plurality of pressure-releasable microcapsules disposed on or embedded in the deformable polymeric layer. Another aspect of the present disclosure is directed to calibration devices for an imaging apparatus, which includes a substrate, a deformable polymeric layer, and a calibration code printed on the first or the second surface of the substrate, or on the deformable polymeric layer, or both.

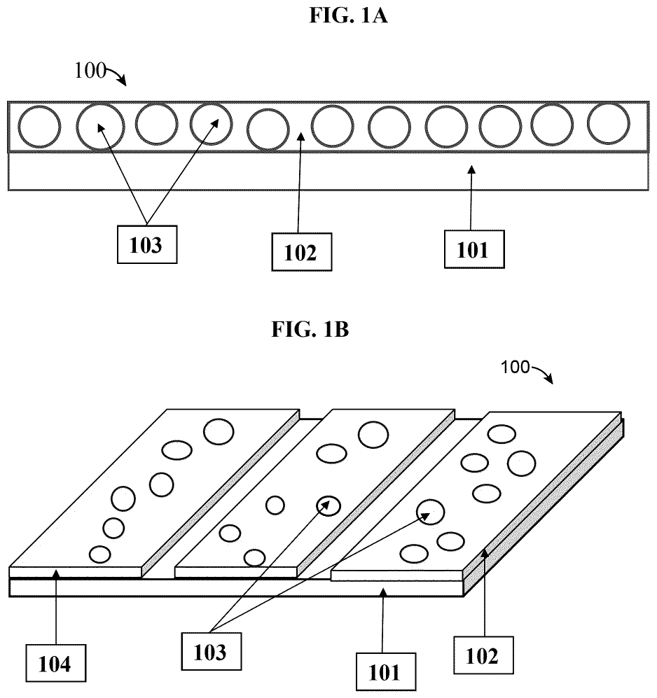

As shown in FIG. 1A (side view) and FIG. 1B (perspective view), an embodiment of cleaning or calibration device (100) for an imaging apparatus of the present disclosure comprises a substrate (101), a deformable polymeric layer (102), and a plurality of plurality of pressure-releasable microcapsules (103). In some embodiments, the deformable polymer layer has a textured pattern (104). The cleaning devices may suitably be in the form of a cleaning sheet, a cleaning roll, and the like. The deformable polymeric layer (102) is disposed on the surface of the substrate (101). The plurality of pressure-releasable microcapsules (103) are disposed on and/or embedded in the deformable polymeric layer. A calibration code may be printed on the first or the second surface of the substrate, or on the deformable polymeric layer, or both (not shown).

The substrate may be selected from, but not limited to, a polymer film, foam, woven or non-woven fabrics, paper, cardboard stock, synthetic paper, and their blends, laminates, composites, and the like and combinations thereof. Suitable polymer films include, without limitation, comprises biaxially oriented polypropylene (BOPP), polyethylene terephthalate (PET), polyethylene naphthalate (PEN), polybutylene terephthalate (PBT), liquid crystalline polymers (LCP), polyvinylchloride (PVC), polystyrene, polyacrylate, polymethacrylate, polycarbonate, polyurethane (PU), polylactic acid (PLA), high density polyethylene (HDPE), low density polyethylene (LDPE), linear low density polyethylene (LLDPE), metallocene polyethylene (mPE), biaxially oriented nylon (BON), polyethylene acrylic acid (EAA), polyethylene vinyl acetate (EVA), polyethylene maleate (EMA), polypropylene, acrylic, acrylonitrile butadiene styrene (ABS), thermoplastic elastomers, and their copolymers, blends, or composites of a combination of any two or more thereof.

The paper may be of any type and form, and includes, without limitation, recording paper, printing paper, writing paper, wallpaper, wrapping paper, colored paper, drawing paper, paper made from pulp and wastepaper as a raw material, and the like. Non-woven fabrics include, without limitation, fiberboard, napkins, kitchen paper, cleaning materials, filter materials, thermal insulation materials, liquid absorbing materials, sound absorbing materials, cushioning materials, and the like. Other substrates may include materials made from raw materials including plant fibers such as cellulose, and animal fibers such as wool and silk. In some embodiments, the polymer film for the substrate includes biaxially oriented polypropylene and polyethylene terephthalate. By way of non-limiting example, the substrate may comprise a commercially-available film such as 146 μm BOPP film (PG146 from Nanya Plastics, Taiwan), HOSTAPHAN® polyester films (Mitsubishi Polyester Film), MELINEX® (DuPont Teijin Films™), and MYLAR® polyester films (DuPont Teijin Films™).

The deformable polymeric layer is disposed or coated on at least one surface, for example, the first surface of the substrate, so that it at least partially covers the first surface of the substrate. The deformable polymer layer is designed and configured to facilitate the removal of contaminants, particles and/or debris from the imaging device. In some embodiments, at least one surface of the substrate, e.g., the first substrate, may have a deformable polymer coating. The deformable polymeric layer may include a rubber (i.e. rubbery) or elastomeric polymer. For example, a rubber polymer may include a kind of polymer that exhibits rubber-like elastic properties and/or has low glass transition (Tg) characteristics. Suitable deformable polymer materials may include, without limitation, silicones, thermoplastic elastomers, and the like. In some embodiments, the deformable polymeric layer includes a rubber polymer. Suitable rubber polymers may include, but are not limited to, silicone rubber, acrylic rubber, natural rubber, acrylonitrile-butadiene rubber, styrene butadiene rubber, alpha-methylstyrene butadiene rubber, neoprene rubber, ethylene propylene diene monomer (EPDM) rubber, ethylene propylene (EPM) rubber, polyurethane rubber (PUR), polybutadiene-polyurethane, silicone-modified polyurethane, and the like, and derivatives thereof; vulcanized or non-vulcanized copolymers; block copolymers; graft copolymers; interpenetration networks thereof; blends; composites; or a combination of any two or more thereof. The rubber or elastomeric polymer, in some embodiments, is a good absorbent for oils, rather than water. In some embodiments, the deformable polymeric layer includes a foam or sponge. The deformable polymeric layer may be open cell or closed cell. By way of non-limiting example, the deformable polymer may comprise a commercially-available polymer such as KM-9772 (silicone rubber emulsion from Shin-Etsu Chemical corp.), CC146 (acrylonitrile-butadiene rubber (NBR) latex from CHENG CI corp.), CC981 (styrene butadiene rubber (SBR) latex from CHENG CI corp.), CC765 (polybutadiene-polyurethane dispersion (PB-PUD) from CHENG CI corp.) and SILIKOPUR® 8081 (waterborne silicone modified polyurethane (Si-PU) dispersion from Evonik Industries AG).

The deformable polymeric layer may be such that at least a portion of the deformable polymeric layer has a textured pattern to further improve the efficiency of the removal of particles and/or debris. In some embodiments, the rubber polymer is a silicone rubber. In some embodiments, the deformable polymeric layer, the substrate or both have at least one surface with a textured pattern. The textured pattern comprises one or more of a trench, a strip, an indentation, a groove, a bump, a ridge, or a tuft pattern, and the like. The textured pattern can be generated using methods known in the art using physical abrasion (such as sandpaper, sand blasting, or the like), ablation (such as by laser ablation), embossing, chemical treatments, electrochemical treatments, or thermal treatments. Suitable examples of textured patterning methods include, but not limited to, one or more of embossing, engraving, sand blasting, stripe coating, printing, lithography, and laser ablation. In some embodiments, the entire deformable polymeric layer has a textured pattern. In some embodiments, the deformable polymeric layer surface carrying the pressure-releasable microcapsules has a textured pattern. In some embodiments, the deformable polymeric layer surface opposite to the surface carrying the pressure-releasable microcapsules has a textured pattern.

The deformable polymeric layer suitably may have a thickness of at least about 2 μm, at least about 3 μm, at least about 4 μm, at least about 5 μm, at least about 6 μm, at least about 7 μm, at least about 8 μm, at least about 9 μm, at least about 10 μm, at least about 15 μm, at least about 20 μm, at least about 25 μm, at least about 30 μm, at least about 35 μm, at least about 40 μm, at least about 45 μm, at least about 50 μm, or any range or value therein. In some embodiments, the deformable polymeric layer has a thickness from about 2 μm to about 35 μm, about 3 μm to about 30 μm, about 4 μm to about 20 μm, or about 5 μm to about 15 μm, or any range or value therein. In some embodiments, the deformable polymeric layer has a thickness of from about 3 μm to about 30 μm, In some embodiments, the deformable polymeric layer has a thickness of from about 5 μm to about 15 μm.

In some embodiments, a plurality of pressure-releasable microcapsules, i.e., the additive microcapsules, are disposed on or embedded in the deformable polymeric layer. In some embodiments, the plurality of pressure-releasable microcapsules are coated on at least one surface of the deformable polymeric layer. Suitable microcapsules include for example, a releasable additive microcapsule to release at least one functional additive onto the printhead or parts along the medium moving path of an imaging device, such as a printer. The pressure-releasable microcapsules can be fully or partially embedded in the deformable polymeric layer or in a separate coating. Alternatively, the pressure-releasable microcapsules can be embedded in the deformable polymeric layer and also present in a separate coating. If present in a separate coating, the pressure-releasable microcapsules may be on the same or different side of the substrate as the deformable polymer layer.

In another aspect, the present technology relates to pressure-releasable microcapsules comprising an outer shell which encapsulates an internal phase comprising at least one functional additive. The pressure-releasable microcapsules can be pressure-sensitive, that is, when pressure is applied, it crushes the microcapsules, releasing the material inside, e.g., for microcapsules containing a functional additive and/or a solvent, application of pressure releases the functional additive and/or a solvent. Each of the plurality of pressure-releasable microcapsules may include an outer shell and an internal phase. Suitable pressure-sensitive or pressure-releasable polymeric materials are known in the art. In some embodiments, the outer shell of the pressure-releasable microcapsules comprises a cross-linkable or crosslinked polymers. Examples of the outer shell material include, but are not limited to, polyurethane, polyurea, polyallophanate, urea formaldehyde resins, melamine formaldehyde resins, phenolic resins, polyamide, carboxymethyl cellulose, gelatine, gum Arabic, chitosan, acrylic resins, methacrylic resins, styrene-maleic anhydride resins, ethylene maleic anhydride resins, and their copolymers, block copolymers, graft copolymers, crosslinked polymers, interpenetrating networks, blends and composites.

The microcapsules can be suitably formed by any known technique including by forming the microcapsules in an emulsion whereby an oily material is dispersed as microdroplets in an aqueous continuous phase followed by simple or complex coacervation, phase separation, interfacial or in-situ polymerization or crosslinking, or their combinations. In some embodiments, multiple shells may be formed to encapsule the internal phase. In some embodiments, a water-in-oil (W/O) emulsion may be formed to prepare microcapsules in an oil phase. In another embodiments, water-in-oil-in-water (W/O/W) may be formed to encapsule water soluble or dispersible ingredients in a water phase. In still another embodiment, microcapsules may be prepared by a membrane process, a multi-orifice or extrusion centrifugal process, a microfluidic process, a spray drying process, etc.

The functional additive included in the one or more pressure-sensitive microcapsules may include, but is not limited to, lubricants, slipping agents, waxes, antistatic agents, corrosion inhibitors, diluents, solvents, stabilizing agents, surfactants, antimicrobials, film forming materials, antimicrobial agents, perfume materials, or flavor materials. Suitable lubricants include, both natural and synthetic lubricants such as for example, an olefin copolymer (OCP) or oligomer, a polyalphaolefin (PAO), a vegetable oil, a mineral oil, and the like, or a combination of any two or more thereof. In some embodiments, the functional additive is a lubricant. In some embodiments, the lubricant is a vegetable oil. Suitable vegetable oils include, but are not limited to, canola oil, rapeseed oil, sunflower oil, safflower oil, olive oil, soyabean oil, and the like, or a combination of any two or more thereof. In some embodiments, the vegetable oil is canola oil.

In some embodiments, the deformable polymeric layer comprises one or more pressure-releasable microcapsules comprising one or more functional additive at a concentration, measured by dry weight relative to the total dry weight of the deformable polymeric layer, of at least about 1 wt. %, at least about 2 wt. %, at least about 3 wt. %, at least about 4 wt. %, at least about 5 wt. %, at least about 6 wt. %, at least about 7 wt. %, at least about 8 wt. %, at least about 9 wt. %, at least about 10 wt. %, at least about 11 wt. %, at least about 12 wt. %, at least about 13 wt. %, at least about 14 wt. %, at least about 15 wt. %, at least about 16 wt. %, at least about 17 wt. %, at least about 18 wt. %, at least about 19 wt. %, at least about 20 wt. %, at least about 25 wt. %, at least about 30 wt. %, or any range or value therein between. In some embodiments, the deformable polymeric layer comprises one or more pressure-releasable microcapsules comprising one or more functional additive, measured by dry weight relative to the total dry weight of the deformable polymeric layer, of less than about 80 wt. %, less than about 75 wt. %, less than about 70 wt. %, less than about 60 wt. %, less than about 50 wt. %, less than about 45 wt. %, less than about 40 wt. %, less than about 35 wt. %, less than about 30 wt. %, less than about 25 wt. %, less than about 20 wt. %, less than about 15 wt. %, less than about 10 wt. % or any range or value therein between.

The pressure-releasable microcapsules suitably have an average microcapsule diameter in the range of about 1 micrometer to about 50 micrometers, including from about 1 to about 40 micrometers, about 2 to about 30 micrometers, about 3 to about 25 micrometers, about 4 to about 20 micrometers, about 5 to about 15 micrometers, or any range or value therein. In some embodiments, the plurality of pressure-releasable microcapsules have an average microcapsule diameter of from about 3 micrometer to about 15 micrometers. In some embodiments, the plurality of pressure-releasable microcapsules have an average microcapsule diameter of from about 4 micrometers to about 12 micrometers.

The cleaning device may be in the form of a cleaning sheet or a cleaning roll. In some embodiments, the cleaning sheet or roll further includes a bar code printed on one side or both sides of the cleaning sheet or roll to facilitate the printer calibration via a calibration code or lookup table or the likes. The calibration code provides characteristic information of the imaging apparatus, characteristic information of a medium used in the imaging apparatus, or characteristic information for both of the imaging apparatus or medium used therein. In another embodiment, the cleaning and/or calibration devices further include an absorbent to help remove the excessive amount of liquid released from the microcapsules, if present. Suitable absorbent materials are known in the art, and may include both natural and synthetic materials, such as foams, fibers, cellulose, clay materials, silica gels, cotton, and the like, or a combination of any two or more thereof.

In one aspect, the present technology relates to calibration device for an imaging apparatus. The calibration device may include a substrate having a first surface and a second surface, a deformable polymeric layer at least partially covering the first surface of the substrate; and a calibration code printed on the first or the second surface of the substrate, or on the deformable polymeric layer, or both. The calibration device may suitably be in the form of a calibration sheet, a calibration roll, and the like. Suitable substrate and deformable polymeric materials are disclosed herein. In some embodiments, the substrate includes a polymer film, foam, fabrics, woven or nonwoven material. In some embodiments, the polymer film includes biaxially oriented polypropylene and polyethylene terephthalate. In some embodiments, the deformable polymeric layer includes a rubber or an elastomeric polymer.

The calibration code suitably provides characteristic information of the imaging apparatus, characteristic information of a medium used in the imaging apparatus, or characteristic information for both of the imaging apparatus or medium used therein. For example, the characteristic information of the imaging apparatus may include, without limitation, manufacturing batch number, manufacturing information, specifications of key parts, compensation weighting factors as compared with a reference apparatus, or a combination thereof. Suitable characteristic information of the medium may include, without limitation, manufacturing batch number, manufacturing information, coefficient of friction, surface roughness, thickness, reflectivity, and media response curves, temperature and/or humidity sensitivity, or any combination thereof. To ensure consistent printing or imaging, a calibration mechanism is often provided to compensate for the batch-to-batch variations of the media and devices.

The calibration device may further include a plurality of pressure-releasable microcapsules disposed on or embedded in the deformable polymeric layer, wherein the pressure-releasable microcapsule includes an outer shell which encapsulates at least one functional additive. Suitable microcapsule and functional additive materials for the calibration device are as described herein for the cleaning device.

The cleaning or calibration devices, such as sheets or rolls, of the present technology can be used in all types and formats of imaging apparatus, such as printers and/or instant photography devices. The imaging apparatus may suitably be selected from the group consisting of a photoprinter, a copier, a thermal printer, a photothermal printer, an inkjet printer, an electrophotographic printer, a portable printer, a pocket printer, an instant camera, and any combination thereof. Suitable photoprinters may include a printhead comprising, for example, a liquid-crystal display (LCD), vacuum fluorescent display (VFD), light-emitting diode (LED) or organic light-emitting diode (OLED) display or array. In some embodiments, the imaging device is a portable printer. Further information regarding exemplary imaging systems, such as an optical printer, is set forth in U.S. application Ser. No. 18/439,465 filed Feb. 12, 2024 (TW application No. 113105369 filed Feb. 15, 2024), International Publication No. WO 2023/228128 published Nov. 30, 2023, U.S. Pat. No. 12,214,603 granted on Feb. 4, 2025 (TW application No. 111119838 filed May 27, 2022), and an application by the Applicant entitled “Calibration Methods For Optical Printer,” (TSW-010; 130952-1900), the entire contents of which are incorporated herein by reference, including for the developer structures and exemplary printer components described therein.

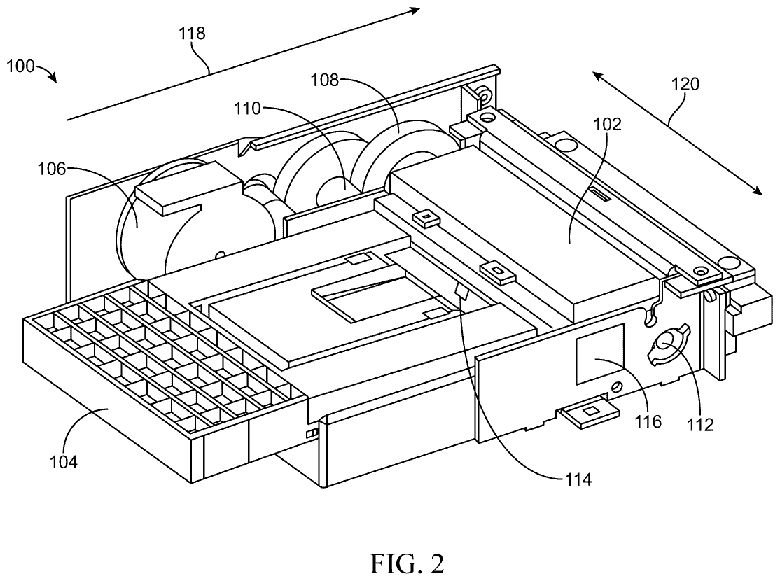

FIG. 2 is a perspective view of an optical printer 100, according to an example embodiment of the present disclosure. The optical printer 100 includes an exposure element array 102 (also referred to as an “LED print head” or “LPH”), a media cassette 104, a media transportation system (e.g., a transporter such as a motor 106, gear train 108, a media roller 110, a developing roller 112), a media sensor 114, and a control unit 116 (e.g., a controller, not shown).

In some embodiments, the control unit 116 is configured to control the various components of the optical printer 100 to perform printing processes for printing an image onto a photosensitive medium dispensed from within the media cassette 104 (e.g., via the media transportation system). For example, the media cassette 104 is configured to store the photosensitive media until it is utilized in a printing process. The media cassette 104 is further configured to prevent the photosensitive medium from being exposed to leaked light while the photosensitive medium is held within the media cassette 104.

The control unit 116 may be programmable to carry out a printing process. The control unit 116 controls the media transportation system to pick up a medium (e.g., film, such as an instant film) using the media roller 110 and to transport the medium along a media transportation direction 118 toward a media exit proximate the media sensor 114. The media sensor 114 (e.g., a photo interrupter sensor) is configured to detect the medium and, when a leading edge of the medium reaches the media sensor 114 (i.e., comes into contact with, obtains a position that is within a specified distance from the media sensor 114), the media sensor 114 detects the medium and the control unit 116 begins a delay timer counter. When the delay timer counter value reaches a preset value (e.g., based on a speed of media advancement and a dimension of the exposure elements within the exposure element array 102), the leading edge of the medium is directly below the exposure element array 102, and the control unit 116 starts the line exposure. For example, the control unit 116 can immediately commence line exposure upon the leading edge of the medium being positioned directly below the exposure element array 102. The exposure element array 102 spans the entire width of the medium (e.g., along a main scan direction 120), such that the exposure element array 102 is configured to expose a full width line of dots on the photosensitive medium. Accordingly, as the medium continues to advance out of the media exit at a constant speed, the control unit 116 continues to trigger the line exposures at a fixed time interval until the whole image is formed on the photosensitive medium.

In another aspect, the present technology relates to methods for cleaning an imaging apparatus having a first feed roller in contact with a printhead configured to print on a print media, and a second feed roller along a print media path. The method may include supplying a cleaning device described herein to the imaging apparatus, moving the cleaning device along the print media path in contact the first feed roller and the second feed roller, while simultaneously releasing the at least one functional additive onto the printhead and/or other parts of the imaging apparatus along the print media path, and removing dust and contaminants adhered to the printhead and/or other parts of the imaging apparatus with the cleaning device.

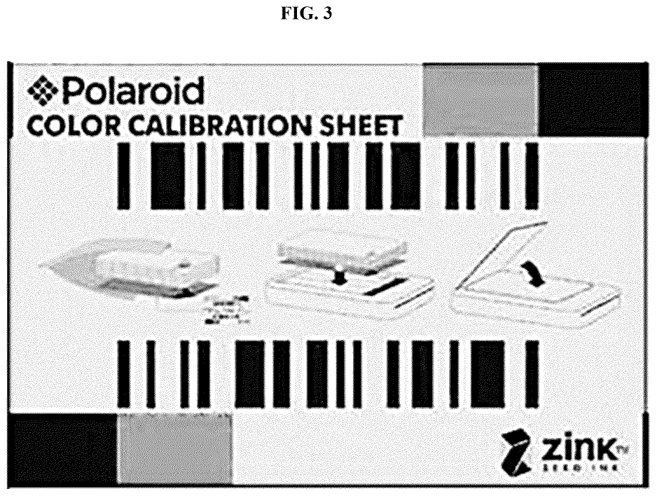

In yet another aspect, the present technology relates to methods for calibrating an imaging apparatus having a first feed roller in contact with a printhead configured to print on a print media, a second feed roller along a print media path. The methods may include supplying a calibration device described herein to the imaging apparatus, moving the calibration device along the print media path in contact the first feed roller and the second feed roller, while simultaneously reading the calibration code, and providing characteristic information from the calibration code to a controller for automatically adjusting at least one calibration setting based on the characteristic information received from the calibration code. A representative calibration sheet for a commercially available portable printer is shown in FIG. 3, wherein the barcode may record the batch numbers, characteristics of the photo media and printer, and optionally the specifications of key components used. The calibration sheet is fed through the printer and read by a sensor. The extracted information allows the printer to adjust the printing parameters accordingly to ensure consistent print quality.

In yet another aspect, the present technology relates to methods for calibrating an imaging apparatus having a first feed roller in contact with a printhead configured to print on a print media, a second feed roller along a print media path. The methods may include supplying a calibration device to the imaging apparatus, moving the calibration device along the print media path in contact the first feed roller and the second feed roller, while simultaneously reading the calibration code and releasing the at least one functional additive onto the printhead and/or other parts of the imaging apparatus along the print media path, and providing characteristic information from the calibration code to a controller for automatically adjusting at least one calibration setting based on the characteristic information received from the calibration code

In one aspect, the present technology provides a new type of printer cleaning sheet or rolls comprising a deformable polymer coating and microcapsules having one or more functional additive to improve the cleaning efficiency as well as the printing performances and/or printing imaging qualities. The one or more functional additives may be released and transferred to the printer components or parts along the media transportation path as the cleaning sheet is fed through the printer. Specific additives may be selected to provide the printer specific functional properties such as lubrication, corrosion inhibition, and antistatic properties, and the like, without any trade-off in the handleability, packaging and/or the transportation properties of the cleaning sheets. The cleaning and calibration devices may be provided separately or combined into a single device, such as a roller or a sheet to provide a low-cost, user-friendly solution to keep the printer clean and provide a printing path of low static charge and consistent friction, as well as to provide a calibration mechanism to ensure consistent printing and to allow compensation for the batch-to-batch variations of the media and devices, for example in portable printing or imaging devices. The cleaning and calibration devices of the present technology enables imaging apparatus such as printers to have improved service longevity or run length, and produce media of a higher image quality with less defects caused by foreign particles/debris and static charge/discharge.

The cleaning and calibration devices and methods of the present technology are advantageous over commonly used methods such as those which use cleaning fluids, cleaning agents, liquid cleaners, waxes, fibers, paper, brushes, adhesives, or a movable cleaning structure. However, these commonly used devices and methods such as those using movable parts or brushes, are often quite noisy and bulky for most portable applications. In some cases, excessive waxes, solvents and/or other cleaning agents are used to clean the devices. The cleaning materials may be accumulated in the printer and interfere with the printing process via for examples, blocking the light path in an optical printer, disrupting the droplet formation, injection and/or deposition processes in an inkjet printer, interfering the charging, exposure, and/or toner deposition processes in a electrophotographic printer. Other commonly used devices require a collection and disposal mechanism for the excessive cleaning materials and debris, and/or additional space to accommodate the moving parts, which are often very costly solutions. The cleaning and/or calibration devices of the present technology do not have these shortcomings.

The cleaning and/or calibration devices of the present technology are designed to have flexibility and thickness so as to assure good contact with the surfaces to be cleaned. Additionally, the tackiness of the cleaning sheets and the textured pattern of the deformable polymeric layer work in tandem when moved across a surface to be cleaned and collect the contaminants, dust, debris, etc. deposited on the surface, and reduce or discharge the static. The patterned surface also helps to reduce the overall stickiness of the rubber polymer and minimize blockages and jams during cleaning. Moreover, upon application of pressure, the pressure-sensitive microcapsules release the functional additives in a controlled-released manner at the desired contact areas of high pressure and/or shear stress. The amount of the functional additive released increases with increasing pressure or shear stress. The microcapsules can be designed to selectively transfer the functional additives to the areas of interest, such as for example, the areas that are most prone to cause abrasion or scratch damage, or those that carry static charge.

The multifunctional devices and methods described herein advantageously provide synergistic functionality of cleaning and calibration function to the imaging apparatus. In addition to effectively cleaning foreign particles, contaminants, dust, and debris, the devices of the present technology possess a plurality of useful features including calibration, static charge, friction, and/or corrosion controls to improve printing quality and printer longevity. Thus the present technology, in one embodiment, provides novel multifunctional devices capable of cleaning the imaging apparatus as well as capable of improving the static charge, friction, and/or corrosion controls. The present technology, in another embodiment, provides novel calibration sheets or rolls capable of cleaning the imaging apparatus. The present technology, in yet another embodiment, provides novel cleaning sheets or rolls capable of improving the static charge, friction, microbial, and/or corrosion controls of the imaging apparatus. The cleaning sheets and rolls of the present technology provide a low-cost, compact, user-friendly and environment-friendly solutions for reproducible, high-quality printing, particularly portable printing or imaging devices. The disclosed calibration methods can be performed at the component level rather than on the finished product, which makes the calibration process highly efficient, and avoids or mitigates the risk of calibration failure.

For the purpose of clarity and concision, features may be described herein as part of the same or separate aspects or embodiments of the present technology. It will be appreciated by the skilled person that the scope of the present technology may include embodiments having combinations of all or some of the features described herein as part of the same or separate embodiments. Although the embodiments may recite a specific order of method steps, the order of the steps may differ, for example, in some embodiments, two or more steps may be performed concurrently or with partial concurrence, and in some embodiments the steps may be carried out in sequence or even reversed. All such variations are within the scope of the disclosure. While various aspects and embodiments have been disclosed herein, other aspects and embodiments will be apparent to those skilled in the art.

Aspects of the present disclosure are explained in more detail in the following, non-limiting examples. The examples are provided to illustrate coating processes applicable to making the particles of the present technology. These examples are not intended to limit the scope of the present technology. All parts and percentages are by weight unless otherwise indicated.

### EXAMPLES

### Materials

TABLE 1

| Tradename | Ingredient |
|---|---|
| KM-9772 | Silicone rubber emulsion from Shin-Etsu Chemical corp. |
| CC146 | NBR latex from CHENG CI corp. |
| CC981 | SBR latex from CHENG CI corp. |
| CC765 | Polybutadiene-polyurethane dispersion (PB-PUD) from CHENG CI |
| | corp. |
| SILIKOPUR ® | Waterborne silicone modified polyurethane dispersion from Evonik |
| 8081 | Industries AG. |
| XIAMETER- | Reactive silicone emulsion (Methyl hydrogen polysiloxane) from |
| 0075 | Dow Chemical Company. |
| SYLOFF-7975 | Platinum catalyst emulsion from Dow Chemical Company. |
| Tamol 165A | Hydrophobic copolymer dispersant from Dow Chemical Company |
| PVA 205 | Polyvinyl alcohol from Kuraray Crop. |
| Aerosol OT | Sodium bis (2-ethylhexyl) sulfosuccinate surfactant from Cytec |
| | Corp. |
| Zemac E60 | Ethylene maleic anhydride copolymer from Aurorium Corp. |
| Versa TL502 | Sulfonated polystyrene from Nouryon Corp. |
| XIRAN 1000P | Random styrene maleic anhydride (SMA) copolymers from |
| | Aurorium Corp. |
| ABEX 18S | Emulsifier from Solvay Corp. |
| Cymel 385 | Methylated melamine resin with a low degree of alkylation from |
| | Allnex Corp. |
| Canola oil | Canola oil from Taisun Enterprise Co., Ltd. |
| ULTRA ATOX | Food-Grade synthetic white oil from Cogelsa Corp. |
| 68 | |
| IRGAMET 39 | Liquid Tolyltriazole Derivative from BASF. |
| S-1008b | Antistatic agent from Sample Fine Enterprise Co., Ltd. |

### Example 1—Preparation of Additive Microcapsules

Two lubricants, canola oil and synthetic lubricant oil ATOX68, were microencapsulated by the processes described below:

An isophorone diisocyanate (IPDI)-castor oil prepolymer was prepared by reacting IPDI and dried castor oil (molar ratio=3.05:1) at 25° C. for 40 min with 250 ppm of dibutyltin dilaurate (DBTDL) as the catalyst. 22.12 parts of the prepolymer thus prepared were mixed thoroughly with 552.88 parts of dried canola oil to form the internal phase. 175.06 parts of a 10 wt. % solution of ZeMac E60 in DI water, 66.69 parts of 15 wt. % of XIRAN 1000P solution in DI water, 15.01 parts of a 10 wt. % solution of ABEX 18S in DI water, and 743.59 parts of DI water were mixed thoroughly at 500 rpm to form the aqueous phase. The pH of the aqueous phase was adjusted to 8.0. The internal phase (575.00 parts) was pre-emulsified in the aqueous phase (1000.35 parts) with a gentle mixing. The resultant pre-emulsion was then pumped through a 30 μm SPG membrane twice, followed by an 8 μm SPG membrane twice to form an internal phase emulsion (emulsion-1).

Then, 9.91 parts of a 10 wt. % solution of ABEX 18S in DI water were added to 1300.00 parts of the internal phase emulsion, and the mixture was stirred at 500 rpm for 10 min to form an internal phase emulsion. 66.04 parts of a 10 wt. % ZeMac E60 solution in DI water, 55.00 parts of a 7.5 wt. % XIRAN 1000P solution in DI water, and 4.75 parts of diethylene triamine (DETA) with the pH preadjusted to 8.0 by a 5% H₃PO₄ solution in DI water, were added to an internal phase emulsion-2. The pH of the resultant emulsion was adjusted to 8.0 and the mixture was stirred at 500 rpm and allowed to react at 25° C. for 15 h. 192.11 parts of a 9.9 wt. % Versa TL502 solution in DI water were added and the resultant slurry was allowed to react at 40° C. for an hour. 104.39 parts of an 18.2 wt. % solution of Na₂SO₄ were added and the pH was adjusted to 6.0. 97.50 parts of Cymel 385 and 97.5 parts of DI water were then added. The resultant mixture was stirred at 700 rpm and allowed to react at 40° C. for 2 h, followed by 70° C. for 3 additional hours to obtain a slurry of microcapsules containing pressure-releasable canola oil as the internal phase. The microcapsule slurry was diluted to about 15 wt. % with DI water, and the pH was adjusted to 9. The diluted slurry was filtered with a 500-mesh sieve and centrifuged twice to remove the aqueous phase.

The same processes were used for the preparation and purification of canola oil microcapsules, except that 552.88 parts of dried ATOX68 synthetic lubricant oil were used to replace the canola oil. The resultant microcapsules were analyzed for particle size distribution by a Laser Diffraction Particle Size Analyzer LA-960V2 from HORIBA., and the particle size was summarized in Table 2.

TABLE 1
Particle Size of Microcapsules Prepared in Example 1

| | | Particle | Particle |
|---|---|---|---|
| | | size (D₅₀) | size (D₅₀) |
| | | (before | (after |
| Example | Description | purification) | purification) |
| Example 1a | Canola oil | 7.52 μm | 6.60 μm |
| Example 1b | Synthetic lubricant | 7.45 μm | 7.23 μm |
| | oil ATOX68 | | |

### Example 2: Preparation of Cleaning Sheets with Deformable Polymeric Coatings

The compositions of the deformable polymer layer, as shown in Table 3, were adjusted to 35 wt. % solid and coated onto the primed side of a 146 μm BOPP film (PG146 from Nanya Plastics, Taiwan) using a doctor blade. The coated films were dried in an oven at 105° C. for 3 minutes to obtain polymer coatings of about 10 μm. The total thickness of the cleaning sheets was approximately 156 μm. The sheets were then cut into 2-inch×3-inch pieces for evaluation.

The cleaning efficiency of the cleaning sheets thus prepared were evaluated based on their dust removal rate and dust retention rate as defined below. The results as well as the coefficient of frictions (COF) of the cleaning sheets against two substrates (PEEK and aluminum plate) as measured by ASTM D1894 are summarized in Table 3.

TABLE 3
Ingredients of the deformable coatings of Example 2

| | Example | Example | Example | Example | Example |
|---|---|---|---|---|---|
| | 2-1 | 2-2 | 2-3 | 2-4 | 2-5 |
| Ingredients [dry parts] | | | | | |
| CC981 (SBR latex) | 100.0 | — | — | — | — |
| CC146 (NBR latex) | — | 100.0 | — | — | — |
| CC765 (PB-PUD) | — | — | 100.0 | — | — |
| KM9772 (SILICONE) | — | — | — | 100.0 | — |
| SILIKOPUR8081 (SiPU) | — | — | — | — | 100.0 |
| XIAMETER-0075 | 0.1 | | | | |
| SYLOFF-7975 | 0.05 | | | | |
| PVA205 | 3.5 | | | | |
| Tamol 165A | 3.5 | | | | |
| Properties | | | | | |
| Dust removal rate (%) | 78% | 83% | 64% | 90% | 59% |
| Dust retention rate (%) | Failed. | Failed. | Failed. | 55% | 7% |
| | Unable | Unable | Unable | | |
| | to pass | to pass | to pass | | |
| | through | through | through | | |
| | printer | printer | printer | | |
| COF(μk) of cleaning sheet | 1.56 | 0.92 | 1.41 | 0.77 | 0.19 |
| against PEEK | | | | | |
| COF(μk) of cleaning sheet | 0.95 | 1.72 | 1.29 | 0.47 | 0.17 |
| against Aluminum plate | | | | | |
| Release force (gf/inch) | 250.3 | 271.7 | 863.5 | 39.0 | 13.5 |
| Loop Tack (N) | 3.07 | 1.46 | 0.31 | 0.36 | 0.00 |

The dust removal rate, dust retention rate, Coefficient of Friction of cleaning sheet against PEEK and Aluminum plate, release force, and loop tack were analyzed using the following methods.

Dust Removal Rate: A PC board substrate precoated with a solder mask was used to measure the efficiency of dust removal by a cleaning sheet. About 60M particles/m² of chalk dust (Supplied by Strong Stationary Manufacturing Co. Ltd., Taiwan, average particle size: 7.18 μm; minimum size: 3.05 μm; maximum size: 11.29 μm, as measured by optical microscopy) as measured by a Keyence VR-6000 optical microscope and analyzed with the Image J particle image processing software, were applied uniformly onto the substrate by a chalk eraser and stored at ambient conditions overnight before test. A 30 mm×15 mm dusted PC board was then placed on the cleaning sheet and pulled at a speed of 110 mm/min for a distance of 76.2 mm with an applied load of 200 g on the cleaning sheet. The pulling speed and applied load were chosen to simulate the actual printing speed and pressure of about 4.5 in/min and 44.5 g/cm², respectively. The dust removal rate from the dusted PC board is defined as:

Dust removal rate=1−(dust coverage after cleaning/dust coverage before cleaning).

Dust Retention Rate: A 2 in×3 in cleaning sheet was dusted with the chalk dust as described above and passed through a photo printer as described in the co-pending US patent application (TSW-002 “Improved Imaging Devices, Apparatus, And Methods For The Development Of Image Recording Media”/Dkt. No. 130952-0400). The dust retention rate of the cleaning sheet is defined as: Dust retention rate=dust coverage after passing through the printer/dust coverage before passing through the printer.

Coefficient of Friction: The dynamic and static friction coefficients between various materials were measured by a friction tester GR-B210 from Cometech Testing Machines, Inc., Taiwan, at 110 mm/min according to ASTM D1894. The characteristics of the two substrates used for the COF measurement against the cleaning sheets are listed below:
PEEK block: 114.5 mm×61.5 mm×6 mm, surface roughness (Ra)=2.17 μm, Rz=30.68 μm, from ZHENGSHENG Module, Taiwan; and
Aluminum plate: 50 mm×10 mm×1 mm, surface roughness (Ra)=0.38 μm, Rz=21.11 μm from ZHENGSHENG Module, Taiwan.

Release Force: The 180° release force of the cleaning sheets against a 3M™ Scotch Tape 810 was measured by an Instron 3367 Universal Testing Systems, at a speed of 300 mm/min.

Loop Tack: The loop tack strength of the cleaning sheets was measured per the FINAT FTM 9 test standard using an Instron 3367 Universal Testing System at a speed of 300 mm/min. A test strip (175 mm in length) was cut from the cleaning sheet, bent to form a loop with the coating surface facing outward, and brought into contact with a glass plate (DGS microscope slides, G15100-00000 from Dogger Science, Taiwan) with a contact area of 1.0 in². The maximum force required to separate the loop from the glass plate was recorded as the loop tack.

### Example 3: Preparation of Cleaning Sheets with (Micro)-Patterns

The cleaning sheets of Example 3 were prepared with the same composition and procedure as those of Example 2-4, except that after the coatings were dried for approximately 20 seconds at 105° C., various trench patterns were created by scraping the partially-dried films with the edge of a series of modified stainless steel meshes based on the 40, 60, and 80 meshes stainless steel grids (from Jun-En Enterprise Corp., Taiwan) made of wires of 240, 180, and 150 μm diameter, respectively. The patterned partially-dried film was then further dried in an oven at 105° C. for 3 minutes to obtain cleaning sheets with various trench patterns to obtain various linewidths and space widths as shown in Table 4 (Example 3-1 to Example 3-12). The target dry thickness of the polymer layer was about 10 μm on a 146 μm BOPP film (PG146 from Nanya Plastics, Taiwan). The thus prepared cleaning sheets were subsequently cut into 2 in ×3 in pieces for evaluations.

The trench patterns were characterized by an optical microscope (Keyence VR-6000) and the actual space width (the average width of the trench or the recessed area), linewidth (the average width of the coating or the raised area), and space/linewidth ratio as measured are summarized in Table 4. The cleaning sheets were fed into the printer with the trench direction aligned perpendicularly to the medium feeding direction and their dust removal rate and retention rate were evaluated and are also summarized in Table 4.

TABLE 4
Cleaning sheets with various trench patterns

| | Space | Line | Space/Line | Dust | Dust |
|---|---|---|---|---|---|
| | width | width | width | removal | retention |
| Example | (um) | (um) | ratio | rate (%) | rate (%) |
| Example 2-4 | — | — | — | 90% | 55% |
| (comparative) | | | | | |
| Example 3-1 | 250 | 9970 | 1/40 | 86% | 59% |
| Example 3-2 | 250 | 5090 | 1/20 | 92% | 59% |
| Example 3-3 | 250 | 2511 | 1/10 | 94% | 65% |
| Example 3-4 | 250 | 1218 | 1/5 | 97% | 84% |
| Example 3-5 | 200 | 6034 | 1/30 | 83% | 62% |
| Example 3-6 | 200 | 2913 | 1/15 | 91% | 74% |
| Example 3-7 | 200 | 1260 | 1/6 | 88% | 82% |
| Example 3-8 | 200 | 630 | 1/3 | 96% | 91% |
| Example 3-9 | 150 | 4506 | 1/30 | 90% | 54% |
| Example 3-10 | 150 | 2277 | 1/15 | 94% | 66% |
| Example 3-11 | 150 | 934 | 1/6 | 87% | 85% |
| Example 3-12 | 150 | 466 | 1/3 | 95% | 93% |

It is evident that almost all of the patterned examples showed a significant improvement in the dust retention rate as compared with the comparative Example 2-4. For samples with the same space width, the dust retention rate appears to increase with a decreasing line width or an increasing space/line width ratio. The dust removal rate shows a similar trend, although the correlation is not as good as that for the dust retention rate.

It is also evident that most of the samples with a trench pattern show superior cleaning efficiencies in both the dust retention and removal rates. Among them, Examples 3-8 and 3-12 having a space/line width ratio of ⅓ and space widths of 200 μm and 150 μm, showed the highest dust retention rates (91% and 93%, respectively) and excellent dust removal rates (96% and 95%, respectively). It appears that the cleaning sheets having a trench pattern with a Space width of about 150 to about 200 μm and a space/line width ratio of about ⅓ on the silicone KM9772/XIAMETER-0075 coating (about 10 μm thick), provided a good balance of dust removal rate and retention rate.

### Example 4: Preparation of Cleaning Sheets with Pressure-Releasable Lubricant Microcapsules Embedded in the Deformable Polymer Coating

The cleaning sheets of Example 4 were prepared by the same procedures as those of Example 2 and 3 except that the compositions as shown in Table 5 were used. The canola oil microcapsules and Atox 68 microcapsules were prepared as described in Example 1.

TABLE 5
Effect of Microencapsulated Lubricant Oil in Non-(Micro)Patterned Cleaning Sheets

| | Example | | | | | | | | | | | | | |
|---|---|---|---|---|---|---|---|---|---|---|---|---|---|---|
| | 4-1 | | | | | | 4-6 | 4-7 | 4-8 | 4-9 | 4-10 | 4-11 | 4-12 | 4-13 |
| | No | 2-4* | 4-2 | 4-3 | 4-4 | 4-5 | Cleaning sheet with | | | | Cleaning sheets with | | | |
| Ingredients | Cleaning | No | Cleaning sheets with | | | | canola oil microcapsules | | | | ATOX 68 microcapsules | | | |
| [dry parts] | sheet | lubricant | canola oil emulsion | | | | from Example 1a | | | | from Example 1b | | | |
| KM-9772 | — | 100 | 99 | 95 | 90 | 80 | 90 | 80 | 70 | 60 | 90 | 80 | 70 | 60 |
| Canola oil | — | — | 0.5 | 1 | 5 | 10 | — | — | — | — | — | — | — | — |
| emulsion | | | | | | | | | | | | | | |
| Canola oil | — | — | — | — | — | — | 10 | 20 | 30 | 40 | — | — | — | — |
| microcapsule | | | | | | | | | | | | | | |
| ATOX 68 | — | — | — | — | — | — | — | — | — | — | 10 | 20 | 30 | 40 |
| microcapsule | | | | | | | | | | | | | | |
| Aerosol OT | — | — | 0.003 | 0.005 | 0.025 | 0.050 | — | — | — | — | — | — | — | — |
| XIAMETER- | — | 0.1 | | | | | | | | | | | | |
| 0075 | | | | | | | | | | | | | | |
| SYLOFF- | — | 0.05 | | | | | | | | | | | | |
| 7975 | | | | | | | | | | | | | | |
| PVA205 | — | 3.5 | 3.53 | 3.55 | 3.75 | 4.00 | 3.5 | 3.5 | 3.5 | 3.5 | 3.5 | 3.5 | 3.5 | 3.5 |
| Tamol 165A | — | 3.5 | | | | | | | | | | | | |
| Scratch | Scratch Counts by Optical Microscope | | | | | | | | | | | | | |
| count on | | | | | | | | | | | | | | |
| PET | | | | | | | | | | | | | | |
| 1st 150 um | 170 | 148 | 142 | 132 | 109 | 111 | 133 | 110 | 108 | 104 | 111 | 96 | 53 | 51 |
| PET pass | | | | | | | | | | | | | | |
| 5th 150 um | 174 | 148 | 154 | 145 | 135 | 120 | 136 | 132 | 115 | 109 | 110 | 92 | 77 | 52 |
| PET pass | | | | | | | | | | | | | | |
| 10th 150 um | 172 | 170 | 165 | 164 | 164 | 137 | 154 | 153 | 134 | 123 | 144 | 109 | 108 | 60 |
| PET pass | | | | | | | | | | | | | | |
| Avg of 10 | 170 | 154 | 150 | 145 | 136 | 131 | 139 | 130 | 121 | 112 | 121 | 101 | 75 | 52 |
| PETs | | | | | | | | | | | | | | |

*(comparative)

The canola oil emulsion used in Examples 4-2 to 4-5 comprises of 100.0 parts of canola oil, 0.5 parts of Aerosol OT, 5.0 parts of PVA 205 and 75.0 parts of DI water. The ingredients as shown in Table 5 were mixed homogeneously to obtain coating fluids of about 40 wt % solid with an average particle size (D50) of about 0.156 mm as measured by a Horiba LA-960V2 laser particle size analyzer. The coating fluids were then coated and dried on a 146 mm BOPP film to obtain the non-(micro) patterned cleaning sheets of Examples 4-2 to 4-13.

The cleaning sheets of Example 4 were evaluated for their capability to transfer the lubricant to the parts along the printing path and reduce the degree of mechanical scratch on the PET test sheets during the subsequent printing operations. The cleaning sheet was passed through a photoprinter comprising a LED printhead, a pressure-development module and a heating device as described previously at a speed of 110 mm/min. Subsequently, ten pieces of 2 in×3 in, 188 μm single-side treated PET BH216 from Nanya Plastics, Taiwan were fed continuously through the printer with the untreated side facing up against the LED printhead and the top surface of the printer components along the media transportation path including rollers, heating plates and the pressure development module. The scratches on each PET sheet were then examined and the number of visible scratches longer than about 1 cm was counted using an optical microscope (Keyence VR-6000). The results are summarized in Table 5.

It was found that all the cleaning sheets comprising non-microencapsulated canola oil as the lubricant are of high stickiness and very poor handleability during the packaging as well as the sheet feeding process. Moreover, severe problems in registration and alignment during the subsequent PET feeding were observed, probably due to the slippage between the feeding roller and the PET sheets caused by the stickiness and/or the uncontrollable oil transfer from the cleaning sheets.

In contrast, the cleaning sheets of Examples 4-6 to 4-13 comprising lubricant oil microcapsules are non-sticky and showed an excellent handleability. Neither slippage between PET test sheets and feeding rollers nor the registration and alignment issues during the subsequent PET feeding were observed. As reflected in Table 5, the Examples using cleaning sheets comprising ATOX 68 microcapsules (Examples 4-10 to 4-13) showed significantly reduced scratch counts on the subsequent PET test sheets as compared to those Examples using cleaning sheets comprising canola oil microcapsules (Examples 4-6 to 4-9) whose scratch counts are significantly less than those using cleaning sheets comprising canola oil emulsion (Examples 4-2 to 4-5) and the two Comparative Examples (Examples 4-1 and 2-4). The PET test sheets fed through the photo-printer without pre-cleaning by any cleaning sheet (Example 4-1) showed the highest scratch counts or the worst scratch resistance. Not to be bound by theory, it is believed that the lubricant microcapsules control-released the lubricant only at the contact areas of high pressure and/or shear stress. The amount of the lubricant released increases with increasing pressure or shear stress. In a fashion, the lubricant microcapsules selectively transfer the lubricant to the areas that are most prone to cause abrasion or scratch damage.

ATOX 68 is a commercially available lubricant optimized for its lubricating properties. ATOX 68 performed better than canola oil, a vegetable oil. ATOX 68 also exhibits a significantly higher kinematic viscosity (68 cSt at 40° C.) than that of canola oil (about 33 cSt at 40° C.), to facilitate the formation and retention of a stable lubricating film on the moving parts for a better lubrication effect.

The effect of micropattern of the cleaning sheets comprising ATOX 68 microcapsules on the dust retention efficiency is summarized in Table 6. Although the addition of lubricant microcapsules to the non-patterned cleaning sheets is very effective to improve the abrasion or scratch resistance of the subsequent printing media, deteriorations in both the dust removal and retention efficiencies of the non-(micro) patterned cleaning sheet were observed, as elucidated by Comparative Example 2-4 and Examples 4-10 to 4-13.

TABLE 6
Effect of Micro-Trenches on The Cleaning Efficiencies
of Cleaning Sheets Comprising ATOX 68 Microcapsules

| | Example | | | | | | | | | |
|---|---|---|---|---|---|---|---|---|---|---|
| Ingredients | 2-4 | | | | | 3-8 | | | | |
| [dry parts] | (comparative) | 4-10 | 4-11 | 4-12 | 4-13 | (comparative) | 4-14 | 4-15 | 4-16 | 4-17 |
| KM-9772 | 100 | 90 | 80 | 70 | 60 | 100 | 90 | 80 | 70 | 60 |
| ATOX 68 | — | 10 | 20 | 30 | 40 | — | 10 | 20 | 30 | 40 |
| microcapsule | | | | | | | | | | |
| XIAMETER- | 0.1 | | | | | | | | | |
| 0075 | | | | | | | | | | |
| SYLOFF- | 0.05 | | | | | | | | | |
| 7975 | | | | | | | | | | |
| PVA205 | 3.5 | | | | | | | | | |
| Tamol 165A | 3.5 | | | | | | | | | |
| Micropattern | None | | | | | Trench Pattern (Space width: | | | | |
| | | | | | | 200 μm Linewidth: 630 μm | | | | |
| | | | | | | Space/Line ratio: 1/3) | | | | |
| Scratch count | 154 | 121 | 101 | 75 | 52 | 150 | 123 | 106 | 77 | 56 |
| on PET (avg. | | | | | | | | | | |
| of 10 PETs) | | | | | | | | | | |
| Dust removal | 90% | 89% | 85% | 83% | 83% | 96% | 93% | 96% | 86% | 85% |
| rate(%) | | | | | | | | | | |
| Dust retention | 55% | 53% | 51% | 43% | 42% | 91% | 89% | 85% | 82% | 76% |
| rate(%) | | | | | | | | | | |

The effects of the micro-trench pattern with a space width of 200 mm and a line width of 630 mm on the scratch resistance and the cleaning efficiencies of the cleaning sheets comprising ATOX 68 lubricant microcapsules embedded in the deformable silicone KM-9772/XIAMETER-0075 network (Comparative Example 3-8, Examples 4-14 to 4-17) are also shown in Table 6. The scratch counts on the PET test sheets decrease or the scratch resistance increase significantly with an increasing dosage of the ATOX 68 microcapsules in the cleaning sheets. The cleaning efficiencies of the trench patterned cleaning sheets decrease slightly with an increasing dosage of the ATOX 68 microcapsules in the cleaning sheets. However, the cleaning efficiencies of the micro-trench patterned cleaning sheets are still significantly better than those of the non-patterned Comparative Example 2-4 and Examples 4-10 to 4-13.

### Example 5: Cleaning Sheets Comprising Microcapsules of Corrosion Inhibitors

A corrosion inhibitor, IRGAMET39 (a liquid tolyltriazole derivative from BASF), was encapsulated in microcapsules using the same microencapsulation process as described in Example 1 except that the 552.88 parts of dried canola oil in the step 2 were replaced with a solution of 11.06 parts (2.0 wt. %) of dried IRGAMET39 in 541.82 parts (98.0 wt. %) of dried ATOX 68 lubricant oil. The resulting lubricant microcapsules had an average median size (D50) of 6.24 mm, as measured by a Laser Diffraction Particle Size Analyzer (LA-960V2, HORIBA).

The cleaning sheets of Example 5 were prepared by the same procedures as those of Example 2 and 3 except that the compositions as shown in Table 7 were used, and the same trench pattern as Examples 3-8 (space/line width ratio of ⅓, a line width of 630 mm, and a space width of 200 μm) was formed on the coating.

TABLE 7

| | Example | | | | | | | | | |
|---|---|---|---|---|---|---|---|---|---|---|
| Ingredients [dry parts] | 5-1 | 5-2 | 5-3 | 5-4 | 5-5 | 5-6 | 5-7 | 5-8 | 5-9 | 5-10 |
| KM-9772 | No | 100 | 90 | 80 | 70 | 60 | 90 | 80 | 70 | 60 |
| ATOX68 microcapsule | Cleaning | 0 | 10 | 20 | 30 | 40 | — | — | — | — |
| from Example 1b | sheet | | | | | | | | | |
| Microcapusle of | | — | — | — | — | — | 10 | 20 | 30 | 40 |
| IRGAMET39 (2.0 | | | | | | | | | | |
| wt. % in ATOX68) | | | | | | | | | | |

| | |
|---|---|
| XIAMETER-0075 | 0.1 |
| SYLOFF-7975 | 0.05 |
| PVA205 | 3.5 |
| Tamol 165A | 3.5 |

The effect of the microencapsulated corrosion inhibitor/lubricant on the corrosion resistance of the printers treated with the micro-patterned cleaning sheets was evaluated by the simulated procedure described below. First, the cleaning sheets were passed through a pressure-development module of the photoprinter used in the previous examples at a speed of 110 mm/min to rupture the microcapsules. The thus released oil phase was transferred onto a copper plate (20 mm×60 mm×0.060 mm, Part #139184 from Centenary Materials Co.) using a friction tester with an applied load of 200 g and a speed of 4.5 in/min.

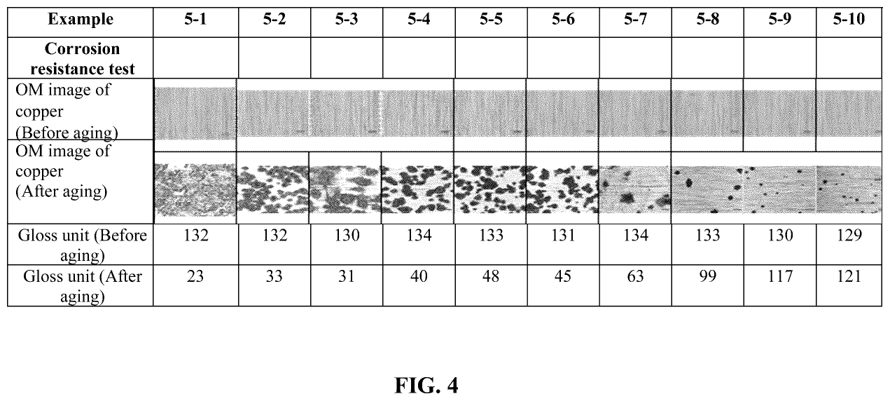

The 20° gloss (measured with IG-331 Gloss Checker from Horiba) of the copper plate samples before aging were recorded. The samples were then sprayed with a 5% NaCl solution and dried in an 80° C. oven for 10 min with a coverage of about 0.05 g/m² and placed in a chamber under accelerated conditions (50° C. and 80% relative humidity) for 24 hours and the 20° gloss after the accelerated aging was measured again. The results and the corresponding optical microscopy (OM) micrographs of the rust spots are summarized in FIG. 4.

As seen from the OM micrographs of the rust spots and the deterioration of the 20° gloss value before and after the accelerated aging, the copper plates with corrosion inhibitor IRGAMET39 transferred from the cleaning sheet (Examples 5-7 to 5-10) showed significantly better corrosion resistance than those copper plates with only lubricant transferred (Examples 5-2 to 5-6) and the bare copper plate (Comparative Example 5-1). The improvement in the corrosion resistance of the treated copper plates increases significantly as the loading of the corrosion inhibitor microcapsule in the cleaning sheet increases.

It is reasonable to expect that the cleaning sheets comprising the corrosion inhibitor microcapsules is capable of improving the corrosion resistance of the metallic parts of the printer and suppress the formation of rust spots along the media transportation path. Since the rust spots are often of high hardness, surface roughness and/or coefficient of friction, the use of a cleaning sheet comprising corrosion inhibitor microcapsules is expected to reduce potential printing defects as well as surface scratches of the media as the printer is aged, particularly in harsh environment.

### Example 6: Preparation of Cleaning Sheets Comprising Microcapsules of Anti-Static Agent

Microcapsules of an oil-soluble antistatic agent, S-1008b (from SAMPLE FINE ENTERPRISE CO., LTD., Taiwan) dissolved in canola oil were prepared by the same microencapsulation process as described in Example 1 except that the 552.88 parts of dried canola oil in the step 2 were replaced with a solution of 27.64 parts (5.0 wt. %) of dried S-1008b in 525.24 parts (95.0 wt. %) of dried canola oil.

The resulting antistatic agent/lubricant microcapsules show an average median size (D50) of 7.12 mm, as measured by a Laser Diffraction Particle Size Analyzer (LA-960V2, HORIBA).

The cleaning sheets of Example 6 were prepared by the same procedures as those of Examples 2 and 3 except that the coating compositions as shown in Table 8 were used, and the same trench pattern as that of Example 3-8 (space/line width ratio of ⅓, line width of 630 mm, and space width of 200 μm) was formed on the silicone coating.

The effect of the microencapsulated anti-static agent/lubricant on the anti-static properties of the printers treated with the micro-patterned cleaning sheets was evaluated by the simulated procedure described below. First, the cleaning sheets were passed through a pressure-development module of the photoprinter used in the previous examples at a speed of 110 mm/min to rupture the microcapsules. The thus released oil phase was transferred onto a PEEK block as described in Example 2 or onto a rubber sheet (250 mm×145 mm×2 mm, surface roughness (Ra)=2.21 μm, Rz=38.29 μm, from ZHENGSHENG Module, Taiwan) using a friction tester with an applied load of 200 g and a speed of 4.5 in/min. The PEEK block and the rubber sheet were employed for the simulated tests since they are the materials used to build the pressure-development module and the rubber rollers in the printer, respectively.

After the oil phase was transferred onto the PEEK block or rubber sheet, repetitive rubbing against the top surface of the image recording sheets prepared with a CH286 film (15 μm clear PET with a top-surface release force of 8.0 g/in, from Nanya Plastics, Taiwan) as the top substrate, were performed by a friction tester at a speed of 4.5 in/min and an applied load of 750 g. Prior to the rubbing, all the samples were treated with an air ionizer (963E from 3M) to reduce the initial static electricity to near 0.00 kV. The static charge accumulated after the rubbing were measured immediately by a portable electrostatic field meter (FMX002, SIMCO, Japan). All the experiments and measurements were conducted at about 20° C. and 65% relative humidity. The results are shown in Table 8.

TABLE 8

| | Example | | | | | | | | | |
|---|---|---|---|---|---|---|---|---|---|---|
| | 6-1 | 6-2 | | | | | | | | |
| | (Comparative) | (Comparative) | 6-3 | 6-4 | 6-5 | 6-6 | 6-7 | 6-8 | 6-9 | 6-10 |
| Cleaning Sheet | | | | | | | | | | |
| Coating | | | | | | | | | | |
| Ingredients | | | | | | | | | | |
| (dry parts) | | | | | | | | | | |
| KM-9772 | No | 100 | 90 | 80 | 70 | 60 | — | — | — | — |
| Canola Oil | Cleaning | 0 | 10 | 20 | 30 | 40 | — | — | — | — |
| Microcapsule | sheet | | | | | | | | | |
| S-1008b/Canola | | — | — | — | — | — | 10 | 20 | 30 | 40 |
| (5/95) | | | | | | | | | | |
| Microcapsule | | | | | | | | | | |
| XIAMETER- | | 0.1 | | | | | | | | |
| 0075 | | | | | | | | | | |
| SYLOFF-7975 | | 0.05 | | | | | | | | |
| PVA205 | | 3.5 | | | | | | | | |
| Tamol 165A | | 3.5 | | | | | | | | |
| Static Charge | | | | | | | | | | |
| Accumulated | | | | | | | | | | |
| on PEEK | | | | | | | | | | |
| Surface (kV) | | | | | | | | | | |
| 1st cycle | 0.30 | 0.21 | 0.21 | 0.20 | 0.21 | 0.19 | 0.14 | 0.15 | 0.03 | 0.08 |
| 5th cycle | 0.55 | 0.57 | 0.47 | 0.45 | 0.35 | 0.34 | 0.27 | 0.32 | 0.24 | 0.20 |
| 10th cycle | 0.70 | 0.74 | 0.61 | 0.57 | 0.77 | 0.60 | 0.40 | 0.34 | 0.31 | 0.32 |
| Static Charge | | | | | | | | | | |
| Accumulated | | | | | | | | | | |
| on Rubber | | | | | | | | | | |
| Sheet Surface | | | | | | | | | | |
| (kV) | | | | | | | | | | |
| 1st cycle | −0.21 | −0.21 | −0.19 | −0.12 | −0.05 | −0.06 | −0.18 | −0.10 | −0.04 | −0.08 |
| 5th cycle | −0.32 | −0.23 | −0.34 | −0.28 | −0.24 | −0.35 | −0.24 | −0.24 | −0.22 | −0.13 |
| 10th cycle | −0.53 | −0.50 | −0.51 | −0.53 | −0.55 | −0.55 | −0.50 | −0.52 | −0.43 | −0.32 |

It is evident from Table 8 that the PEEK blocks and rubber sheets treated with the cleaning sheets comprising various amount of antistatic agent S-1008b/canola oil (5 wt. %/95 wt %) microcapsules (Examples 6-7 to 6-10) showed a significantly less accumulated surface static charge after the rubbing tests against the image recording media as compared to those treated with the cleaning sheet comprising only canola microcapsules (Examples 6-3 to 6-6) and those of the two comparative Examples 6-1 (without any cleaning sheet treatment) and 6-2 (treated with a cleaning sheet without any oil microcapsule). It appears that the canola oil microcapsules also showed a weak antistatic effect as compared with the two comparative Examples 6-1 and 6-2, probably due to their lubrication effect.

The effect of antistatic agent/lubricant microcapsules in the cleaning sheet was also evaluated by a pressure-development module of a photo-printer. First, a cleaning sheet was passed through the pressure-development module at a speed of 110 mm/min to rupture the microcapsules and release and transfer the oil phase of the microcapsules to module. Photosensitive image recording media (total thickness of about 208 μm) with a 15 μm clear PET CH286 (release force of 8 g/in, from Nanya Plastics, Taiwan) as the top substrate were sequentially fed into the pressure-development module which was disassembled after the 1st, 5th and 10th pieces of the media were passed through. The accumulation of static charge in the medium-module contact area and the roller was then measured immediately. The results are summarized in Table 9.

TABLE 9

| | | 6-11 | | |
|---|---|---|---|---|
| | Example | (Comparative) | 6-6 | 6-10 |
| Cleaning | KM-9772 | No Cleaning | 60 | 60 |
| Sheet Coating | Canola Oil Microcapsule | Sheet Pre- | 40 | — |
| Ingredients | S-1008b/Canola (5/95) | treatment | — | 40 |
| (dry parts) | Microcapsule | | | |

| | |
|---|---|
| XIAMETER-0075 | 0.1 |
| SYLOFF-7975 | 0.05 |
| PVA205 | 3.5 |
| Tamol 165A | 3.5 |

| | No. of Media Passed | Static Charge | | |
|---|---|---|---|---|
| | Through Module | Accumulated (kV) | | |
| On Module | 1 | 0.74 | 0.65 | 0.41 |
| Contact | 5 | 0.99 | 0.74 | 0.53 |
| Area | 10 | 1.10 | 0.82 | 0.54 |
| On Rubber | 1 | −0.70 | −0.66 | −0.55 |
| Roller | 5 | −0.97 | −0.75 | −0.68 |
| | 10 | −1.22 | −1.13 | −0.84 |

As can be seen clearly from Table 9 that the static charge accumulated on both the module contact area and the rubber roller were significantly reduced by the pretreatment of the pressure development module with the cleaning sheets comprising the canola oil microcapsules (Examples 6-6 and 6-10). The antistatic effect held very well even after 10 pcs of media were passed continuously through the pressure-development module. The lubricant microcapsules containing 5 wt. % of antistatic agent S-1008b (Example 6-10) showed an even more pronounced effect.

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, compounds, compositions, or structures, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1.-31. (canceled)

32. A cleaning device for an imaging apparatus, the cleaning device comprising:
(i) a substrate having a first surface and a second surface;
(ii) a deformable polymeric layer at least partially covering the first surface of the substrate, the deformable polymeric layer optionally having a textured pattern; and
(iii) a plurality of pressure-releasable microcapsules disposed on or embedded in the deformable polymeric layer, one or more of the pressure-releasable microcapsules comprising an outer shell which encapsulates at least one functional additive.

33. The cleaning device of claim 32, wherein the cleaning device comprises a cleaning sheet or a cleaning roll.

34. The cleaning device of claim 32, wherein the plurality of pressure-releasable microcapsules are (a) embedded or partially embedded in the deformable polymeric layer, or (b) coated on at least one surface of the deformable polymeric layer.

35. The cleaning device of claim 32, wherein the outer shell of the pressure-releasable microcapsules comprises a crosslinked polymer.

36. The cleaning device of claim 32, wherein the at least one functional additive comprises a lubricant, a slipping agent, a wax, an antistatic agent, a corrosion inhibitor, a diluent, a solvent, a stabilizing agent, a surfactant, a film forming material, an antimicrobial, a perfume material, or flavor material.

37. The cleaning device of claim 36, wherein the lubricant comprises at least one of an olefin copolymer (OCP) or oligomer, a polyalphaolefin (PAO), or a vegetable oil, optionally wherein the vegetable oil is canola oil.

38. The cleaning device of claim 32, wherein the substrate comprises a polymer film, foam, woven or non-woven fabrics, paper, cardboard stock, synthetic paper, and their blends, laminates, or composites.

39. The cleaning device of claim 38, wherein the polymer film comprises biaxially oriented polypropylene (BOPP), polyethylene terephthalate (PET), polyethylene naphthalate (PEN), polybutylene terephthalate (PBT), liquid crystalline polymers (LCP), polyvinylchloride (PVC), polystyrene, polyacrylate, polymethacrylate, polycarbonate, polyurethane (PU), polylactic acid (PLA), high density polyethylene (HDPE), low density polyethylene (LDPE), linear low density polyethylene (LLDPE), metallocene polyethylene (mPE), biaxially oriented nylon (BON), polyethylene acrylic acid (EAA), polyethylene vinyl acetate (EVA), polyethylene maleate (EMA), and their copolymers, blends, or composites of a combination of any two or more thereof.

40. The cleaning device of claim 39, wherein the polymer film comprises biaxially oriented polypropylene and polyethylene terephthalate.

41. The cleaning device of claim 32, wherein the deformable polymeric layer comprises a rubber or elastomeric polymer, wherein the rubber or elastomeric polymer is selected from the group consisting of silicone rubber, acrylic rubber, natural rubber, acrylonitrile-butadiene rubber, styrene butadiene rubber, alpha-methylstyrene butadiene rubber, neoprene rubber, ethylene propylene diene monomer (EPDM), rubber, ethylene propylene (EPM) rubber, polyurethane rubber (PUR), polybutadiene-polyurethane, silicone-modified polyurethane, and derivatives thereof; vulcanized or non-vulcanized copolymers; block copolymers; graft copolymers; interpenetration networks thereof; blends; composites; or a combination of any two or more thereof.

42. The cleaning device of claim 32, wherein at least a portion of the deformable polymeric layer has a textured pattern.

43. The cleaning device of claim 42, wherein the textured pattern comprises one or more of a trench, a strip, an indentation, a groove, or a bump, or wherein the textured pattern is generated by one or more of embossing, engraving, sand blasting, stripe coating, printing, lithography, and laser ablation.

44. The cleaning device of claim 32, wherein the deformable polymeric layer comprises a foam or sponge.

45. The cleaning device of claim 32, further comprising a calibration code printed on at least one side of the cleaning device.

46. The cleaning device of claim 32, wherein the imaging apparatus is selected from the group consisting of a photoprinter, a copier, a thermal printer, a photothermal printer, an inkjet printer, an electrophotographic printer, a portable printer, a pocket printer, an instant camera, and any combination thereof; optionally wherein the photoprinter is equipped with a liquid-crystal display (LCD), vacuum fluorescent display (VFD), light-emitting diode (LED) or organic light-emitting diode (OLED).

47. The cleaning device of claim 32, wherein the plurality of pressure-releasable microcapsules have an average microcapsule diameter of from about 1 micrometer to about 15 micrometers.

48. The cleaning device of claim 32, wherein the deformable polymeric layer has thickness of from about 3 μm to about 30 μm.

49. A calibration device for an imaging apparatus, the calibration device comprising:
(i) a substrate having a first surface and a second surface;
(ii) a deformable polymeric layer at least partially covering the first surface of the substrate; and
(iii) a calibration code printed on the first or the second surface of the substrate, or on the deformable polymeric layer, or both;
wherein the calibration code provides characteristic information of the imaging apparatus, characteristic information of a medium used in the imaging apparatus, or characteristic information for both of the imaging apparatus or medium used therein.

50. The calibration device of claim 49, wherein the calibration device is a calibration sheet or roll.

51. The calibration device of claim 49, wherein:
(a) the characteristic information of the imaging apparatus comprises manufacturing batch number, manufacturing information, specifications of key parts, or a combination thereof; or
(b) wherein the characteristic information of the medium comprises manufacturing batch number, manufacturing information, coefficient of friction, surface roughness, thickness, reflectivity, and media response curves, or any combination thereof.

52. The cleaning device of claim 49, further comprising a plurality of pressure-releasable microcapsules disposed on or embedded in the deformable polymeric layer, wherein the pressure-releasable microcapsule comprises an outer shell which encapsulates at least one functional additive.

53. A method for cleaning an imaging apparatus having a first feed roller in contact with a printhead configured to print on a print media, and a second feed roller along a print media path, said method comprising:
supplying the cleaning device of claim 32 to the imaging apparatus;
moving the cleaning device along the print media path in contact the first feed roller and the second feed roller, while simultaneously releasing the at least one functional additive onto the printhead and/or other parts of the imaging apparatus along the print media path; and
removing dust and contaminants adhered to the printhead and/or other parts of the imaging apparatus with the cleaning device.

54. A method for calibrating an imaging apparatus having a first feed roller in contact with a printhead configured to print on a print media, a second feed roller along a print media path, said method comprising:
supplying the calibration device of claim 49 to the imaging apparatus;
moving the calibration device along the print media path in contact the first feed roller and the second feed roller, while simultaneously reading the calibration code and cleaning the device; and
providing characteristic information from the calibration code to a controller for automatically adjusting at least one calibration setting based on the characteristic information received from the calibration code.

55. A method for calibrating an imaging apparatus having a first feed roller in contact with a printhead configured to print on a print media, a second feed roller along a print media path, said method comprising:
supplying the calibration device of claim 49 to the imaging apparatus;
moving the calibration device along the print media path in contact the first feed roller and the second feed roller, while simultaneously reading the calibration code and releasing the at least one functional additive onto the printhead and/or other parts of the imaging apparatus along the print media path; and
providing characteristic information from the calibration code to a controller for automatically adjusting at least one calibration setting based on the characteristic information received from the calibration code.
